(19) United States
(12) Patent Application Publication
(10) Pub. No.: US 2006/0206384 A1
(43) Pub. Date: Sep. 14, 2006

(54) Game medium renting machine management server and game medium renting machine management system

(75) Inventors: Nobuyuki Nonaka, Tokyo (JP); Kazuei Yoshioka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Aruze Corp., Koto-ku (JP); Seta Corp., Koto-ku (JP)

(21) Appl. No.: 11/353,157

(22) Filed: Feb. 14, 2006

(30) Foreign Application Priority Data
Feb. 28, 2005 (JP) P2005-054659
Mar. 15, 2005 (JP) P2005-073100

(51) Int. Cl. G06Q 20/00

(52) U.S. Cl. 705/16

(57) ABSTRACT

A game medium renting machine management system comprises a plurality of game medium renting machines that rent a game medium when money is inserted, a remote control unit capable of communicating with each of the game medium renting machines and a management server connected via a network to each of the game medium renting machines. Each game medium renting machine comprises a holding case for accommodating bills and a motor for providing the thrust to discharge bills accommodated inside the holding case. Further, the management server sends a discharge instruction signal to at least one among the plurality of game medium renting machines when a discharge request signal is input from the remote control unit and input part via a game medium renting machine and the network.

### CROSS REFERENCE TO RELATED APPLICATIONS

This application is based upon and claims the benefit of priority from the Japanese Patent Application No. 2005-054659 filed on Feb. 28, 2005 and No. 2005-073100 filed on Mar. 15, 2005 in the Japanese Patent Office; the entire contents of which are incorporated herein by reference.

### BACKGROUND OF THE INVENTION

1. Field of the Invention

The present invention relates to a management system and management server for managing a game medium renting machine that rents a game medium such as a ball used in a pachinko gaming machine or a medal used in a pachinko slot machine.

2. Description of the Related Art

In the case of a pachinko gaming machine for example, a game medium renting machine for issuing pachinko balls to a player is positioned in the vicinity of the side of the casing of the pachinko gaming machine. The game medium renting machine rents the required number of game balls or medals corresponding to the amount paid, when the player inserts bills or a cash value card such as a prepaid card or the like.

The bills or cash value card inserted into the game medium renting machine by a player is accommodated in an accommodation part inside the game medium renting machine. After the game hall shuts for business the staff member responsible for collecting the money unlocks each of the locks of the respective game medium renting machines and collects the bills or cash value cards held in the accommodation part inside the machine. This work of collecting the takings cannot be performed efficiently however, because the staff member collecting the money is not able to easily get hold of the bills or cash value cards inside the machine when he/she unlocks the lock of each game medium renting machine.

To solve these problems different solutions have been proposed. For example in Japanese Unexamined Patent Application Publication No. 2002-85797 (cited document 1) a technology is disclosed wherein bills accommodated inside a renting machine are automatically delivered outward when the lock of the machine is unlocked. Introduction of this technology enables a staff member collecting money to obtain the bills more easily.

Nonetheless, in the case of the game medium renting machine disclosed in that cited document 1 a staff member collecting money when there are a lot of game medium renting machines in a game hall must still perform the laborious task of unlocking each machine walking around to the machines in turn, to unlock them and collect the bills or cash value cards.

In order to solve this problem, Japanese Unexamined Patent Application Publication No. 2003-190611 (cited document 2) discloses a technology in which a number of machines from among a plurality of game medium renting machines can be opened at once in response to an instruction from a managing server connected via a network to each of the machines, thereby reducing the workload of a staff member collecting money.

Again however, the technology disclosed in cited document 2 is a system in which all or a number of machines from among a plurality of game medium renting machines are unlocked in response to an instruction issued from a management server, thus a staff member collecting money must perform certain operations at the place at which the management server is located and unlock the locks of the game medium renting machines.

Accordingly, if a management server is installed at a location separate from the location at which the game medium renting machines are located the staff member concerned must move to the place at which the management server is located and perform the operation for the unlocking of the machines. Further, after all of the plurality of renting machines have been unlocked simultaneously there is a risk that bills protruding from machines that are late in the order as the staff member concerned comes to collect the money from each one in turn, may be stolen.

With the foregoing in view, it is an object of the present invention to provide a management server and management system for a game medium renting machine that enables a staff member charged with collecting money from game medium renting machines to discharge the bills from the machines for collection by performing a simple operation.

### BRIEF SUMMARY OF THE INVENTION

The primary feature provided in the present invention is a game medium renting machine management server connected via a network to a plurality of game medium renting machines capable of communicating with a portable device which can be carried by an operator, that manages each of the game medium renting machines, comprising: a signal receiver configured to receive a signal sent from any of the game medium renting machines; a signal sender configured to send a signal to any of the game medium renting machines; and a control part configured to control sending of a discharge instruction signal from the signal sender to at least one of the game medium renting machines if a discharge request signal is sent from the portable device and is received by the signal receiver via any of the game medium renting machines and the network.

The secondary feature provided in the present invention is a game medium renting machine management system comprising a plurality of game medium renting machines that rent a game medium when a bill or a cash value card is inserted, a portable device capable of communication between itself and each of the game medium renting machines and a management server connected via a network to the plurality of game medium renting machines, that manages each of the game medium renting machines wherein: each game medium renting machine comprises a communicating means capable of performing communication between itself and the portable device; a holder configured to accommodate inserted bills or cash value cards; and a money discharger configured to discharge bills or cash value cards accommodated inside the holder; and the management server comprises a signal receiving means for receiving a signal sent from any of the game medium renting machines; a signal sender configured to send a signal to any of the game medium renting machines; and a control part configured to control the sending of a discharge instruction signal from the signal sender to at least one of the game medium renting machines when a discharge request signal is sent from the portable device and received at the signal receiver via the game medium renting machine and the network.

### BRIEF DESCRIPTION OF THE DRAWINGS

FIG. 1 is a network connection diagram showing the configuration of the game medium renting machine management system related to a first embodiment of the present invention;

FIG. 2 is a perspective view from the outside of the game medium renting machine shown in FIG. 1;

FIG. 3 shows the state of a plurality of game medium renting machines installed in a game hall;

FIG. 4 is a perspective view showing the construction of the holding case;

FIG. 5 is a side view showing the configuration inside the holding case;

FIG. 6A shows the condition in which bills are accommodated inside the bills holding case, FIG. 6B is an explanatory drawings showing the condition in which bills are dispensed from the case;

FIG. 7 is a block diagram showing the configuration of the inserted-bill detection device;

FIG. 8 is a block diagram showing the configuration of the remote control unit;

FIG. 9 is a block diagram showing the configuration of the management server;

FIG. 10 is a sequence diagram showing the operations of the game medium renting machine management system related to the first embodiment;

FIG. 11 shows an example of group setting data for the first embodiment;

FIG. 12 illustrates how a release signal is output from the management server to the plurality of renting machines in a group, in the case of the first embodiment;

FIG. 13 shows an example of group setting data for the second embodiment;

FIG. 14 is a sequence diagram showing the operations of the game medium renting machine management system related to the second embodiment;

FIG. 15 illustrates bow an release signal is output from the management server to the plurality of renting machines in a first group and the timing thereof, in the case of the second embodiment;

FIG. 16 illustrates how an release signal is output from the management server to the plurality of renting machines in a second group and the timing thereof, in the case of the second embodiment;

FIG. 17 is a network connection diagram of a management system connecting a management server and each game medium renting machine using the Internet;

FIG. 18 is a network connection diagram of a management system providing a relay device between a game medium renting machine and a management server;

FIG. 19 shows a slot machine that can be used with the present invention and the cabinet disposed beside the slot machine; and

FIG. 20 is an enlarged perspective view of the second cabinet part shown in FIG. 19.

### DETAILED DESCRIPTION OF THE INVENTION

The first and second embodiments of the present invention will now be described with reference to the drawings.

### First Embodiment

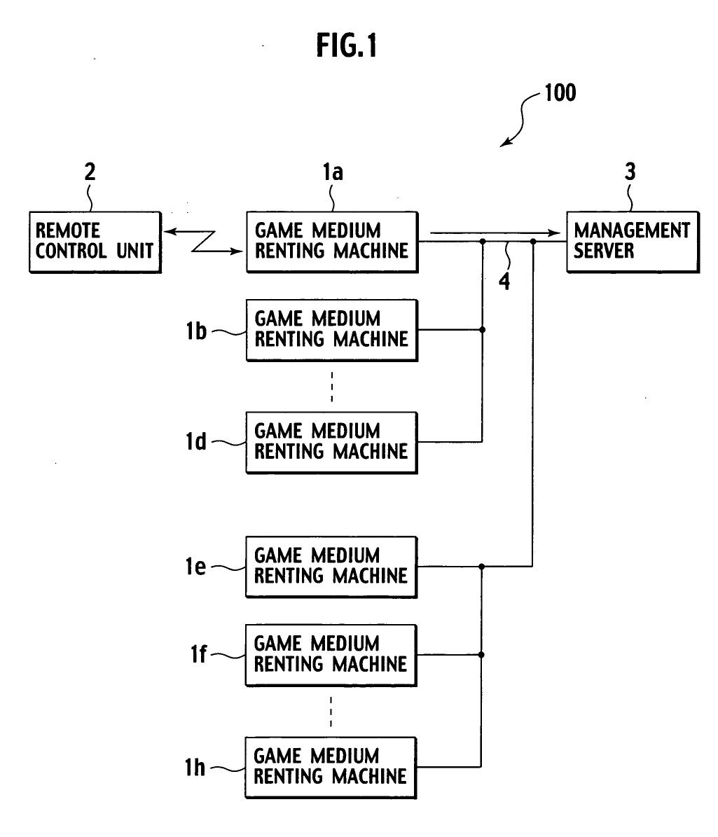

As shown in FIG. 1, the game medium renting machine management system 100 basically comprises a plurality of game medium renting machines 1 installed inside a game hall, a remote control unit (portable unit) 2 capable of communicating with each of the game medium renting machines 1 and a management server 3 connected via a network 4 to each of the game medium renting machines.

Each of the game medium renting machines 1 are disposed for example near the side part of the respective cabinets of pachinko gaming machines in a game hall, and if notes (or a money value card such as a prepaid card for example) is inserted into a renting machine, the appropriate number of game balls (the game medium) corresponding to the amount input are dispensed.

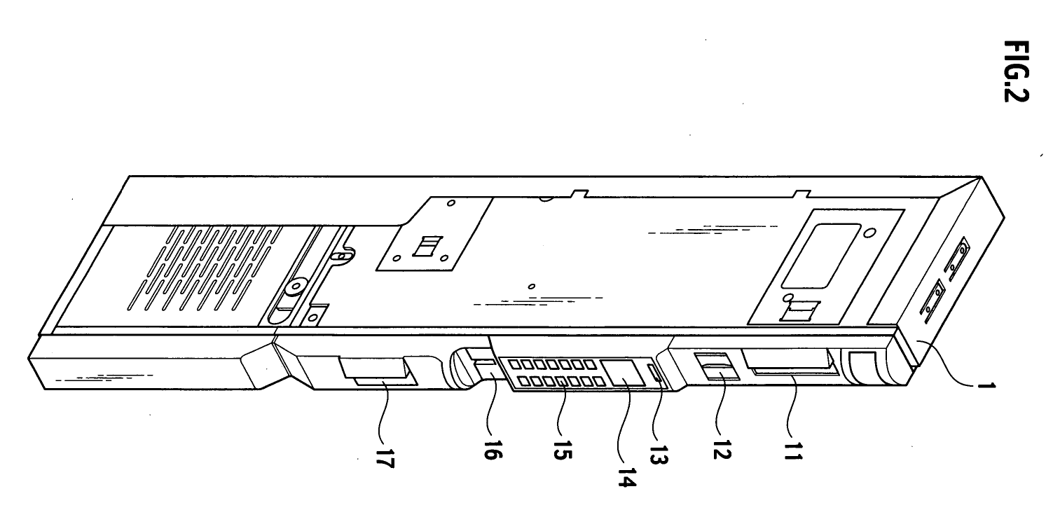

FIG. 2 is a perspective view showing the outside of a game medium renting machine. As shown in FIG. 2 a game medium renting machine 1 provides a bills insertion opening 11 into which bills are inserted, a coins insertion opening 12 into which coins are inserted, a remote control receiving part 13 that operates when communication takes place between a remote control unit 2 and the receiving part 13, an information display LCD 14 for showing information about a member or management information or the like, a numeric keypad 15 for performing operations such as withdrawing accumulated balls, a coins refund opening 16 and a card insertion opening 17 for insertion of a cash value card such as a prepaid card or the like.

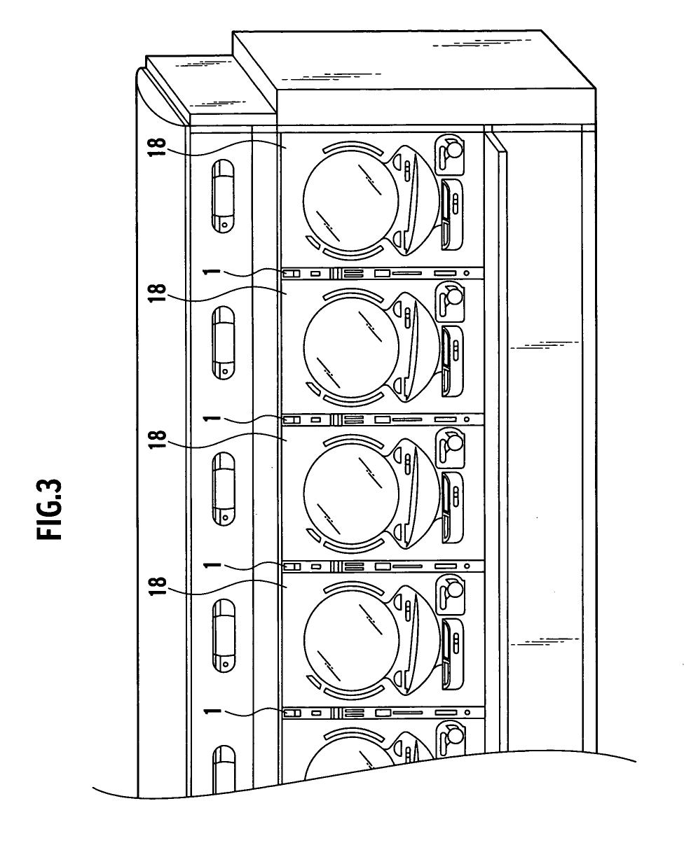

FIG. 3 is an explanatory drawing showing the state when a plurality of game medium renting machines 1 are installed between gaming machines such as pachinko gaming machines 18 or the like. As shown in FIG. 3, a single game medium renting machine 1 is installed for each gaming machine 18. When a player inserts bills via the bills insertion opening 11 of a game medium renting machine 1 or inserts coins via the coins insertion opening 12 or a prepaid card via the card insertion opening 17, in the case of a pachinko gaming machine the gaming machine 18 rents game balls and in the case of a pachinko slot machine the gaming machine 18 rents medals for the game.

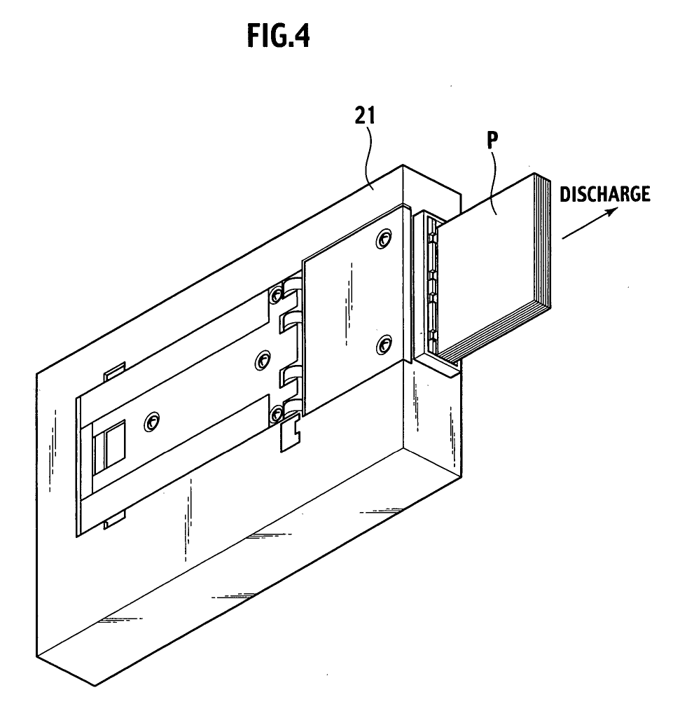

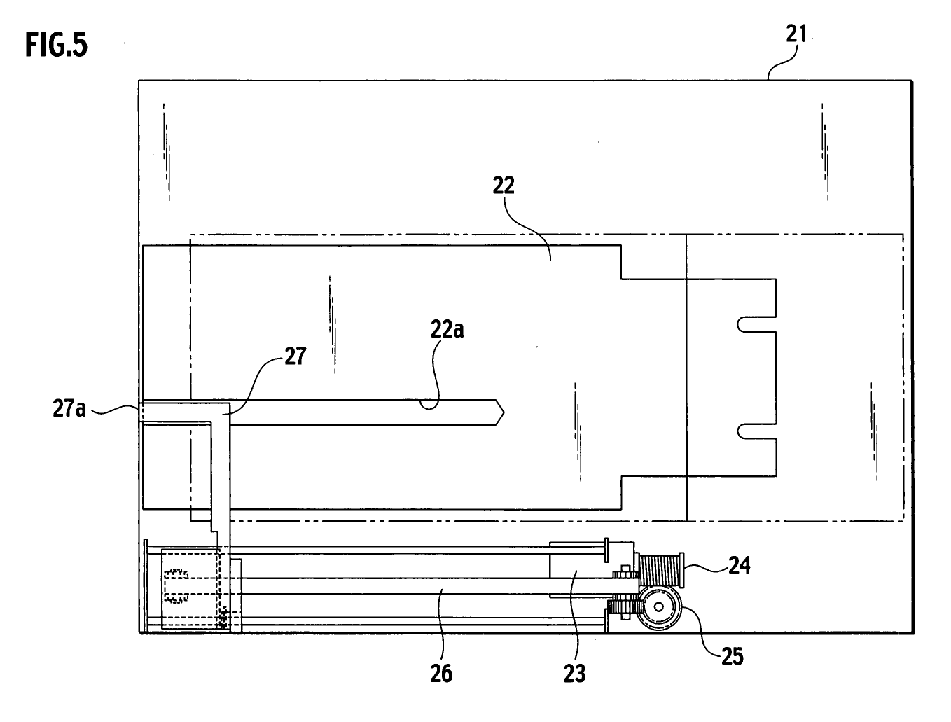

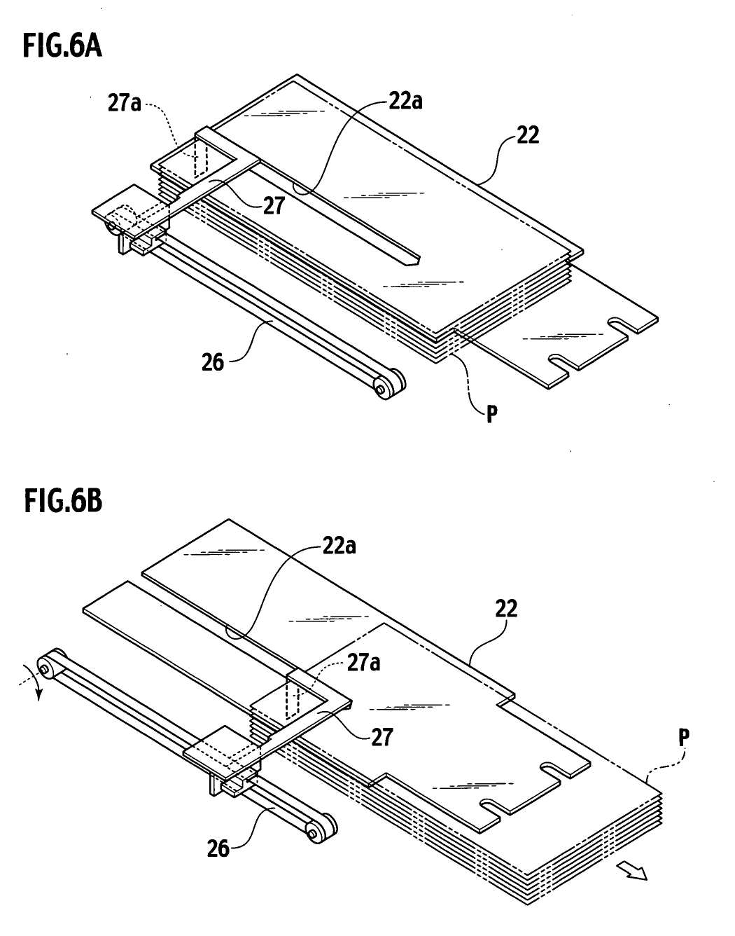

FIG. 4 is a perspective view of the outside of the holding case 21 for accommodating bills P inserted from the bills insertion opening 11 and FIG. 5 is a side view showing the configuration inside the bills holding case. FIG. 6 is a perspective view showing the configuration of the discharge mechanism for discharging bills accommodated inside the holding case 21, FIG. 6A showing the condition in which bills P are inserted and FIG. 6B showing the condition in which bills P are discharged.

As shown in FIG. 5 a metal sideboard 22 is disposed inside the holding case 21 and a number of bills inserted by a player via the bills insertion opening 11 are accommodated along this metal sideboard. A linear notch part 22a is formed from one of the narrow sides of the metal sideboard 22 toward substantially the center part of the holding case 21.

Moreover, a pushing out motor 23 is disposed under the metal sideboard 22, together with a worm gear 24 provided on the rotation axis of the pushing out motor 23, as well as a worm wheel 25 that bites together with the worm gear 24 and a drive belt 26 that operates by each of the gears. Further, a crank shaped bracket 27 for pushing out bills is attached to the drive belt 26, while the end part 27a of the bracket 27 engages inside the notch part 22a of the metal sideboard 22. Accordingly, as shown in FIG. 6, with the bracket 27 in the initial position, when the pushing out motor 23 rotates and drives the drive belt 26, the end part 27a of the bracket 27 moves along the notch part 22a such that, as shown in FIG. 6B, the bills P are pushed out and as shown in FIG. 4 those bills P are discharged from the bills insertion opening 11.

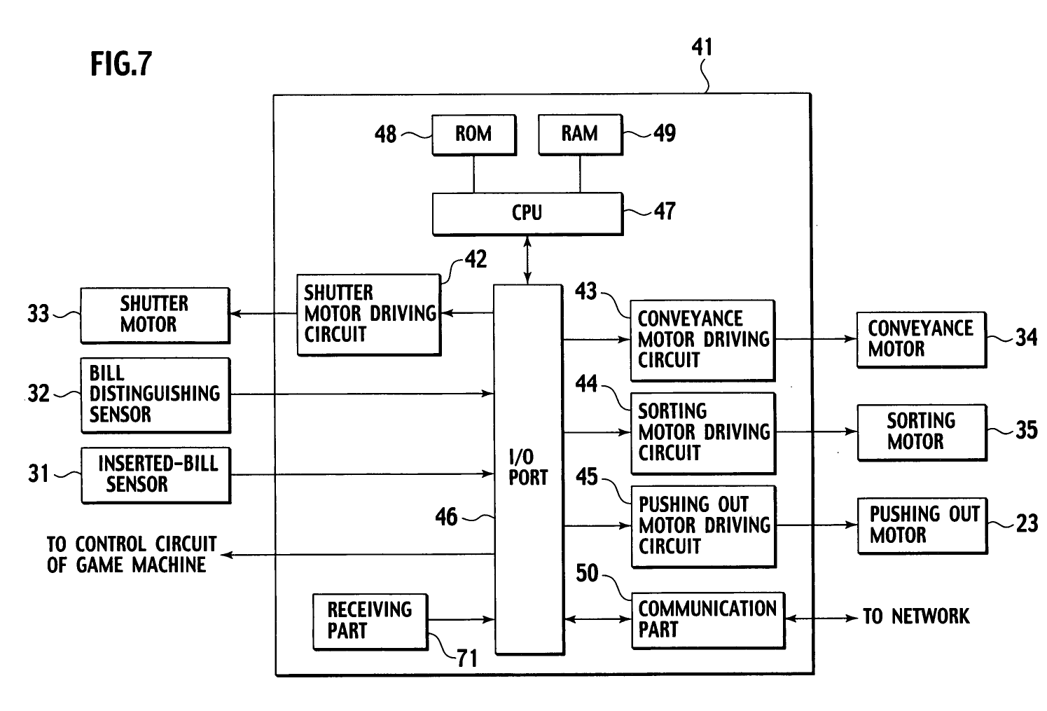

FIG. 7 is a block diagram showing the configuration of inserted-bill detection device disposed in the bills insertion opening 11. As shown in FIG. 7 the inserted-bill detection device provides an inserted-bill sensor 31 for detecting that bills have been inserted from the bills insertion opening 11, a bill distinguishing sensor 32 that distinguishes between bills inserted from the bills insertion opening 11, a shutter motor 33 that controls the opening and closing of a shutter (not shown in the drawing) disposed in the insertion part of the bills insertion opening 11, a conveyance motor 34 that conveys inserted bills to the identification location (not shown in the drawing) in response to the operation of the bill distinguishing sensors 32, a sorting motor 35 that delivers bills for which the identification process performed by the bill distinguishing sensors 32 is complete to the determined holding position inside the holding case 21 and a pushing out motor 23 that discharges bills accommodated inside the holding case 21. Further, a control circuit 41 is provided that controls each motor based on detection signals of each sensor.

The control circuit 41 provides a shutter motor driving circuit 42 that outputs drive signals to the shutter motor 33, a conveyance motor driving circuit 43 that outputs drive signals to the conveyance motor 34, a sorting motor driving circuit 44 that outputs drive signals to the sorting motor 35 and a pushing out motor driving circuit 45 that outputs drive signals to the pushing out motor 23.

Moreover, an input/output port (I/O port) 46 for inputting and outputting each kind of signal, a CPU 47 that performs a variety of controls such as for identification or storage of bills or discharging bills, a ROM 48 for storing a system program and a RAM 49 for storing each kind of data are provided.

Furthermore, the system further provides a receiving part 71 that receives transmitted signals transmitted from the remote control unit 2 and a communication part 50 that performs signal-transmission to and signal-reception from the management server 3 via the network 4.

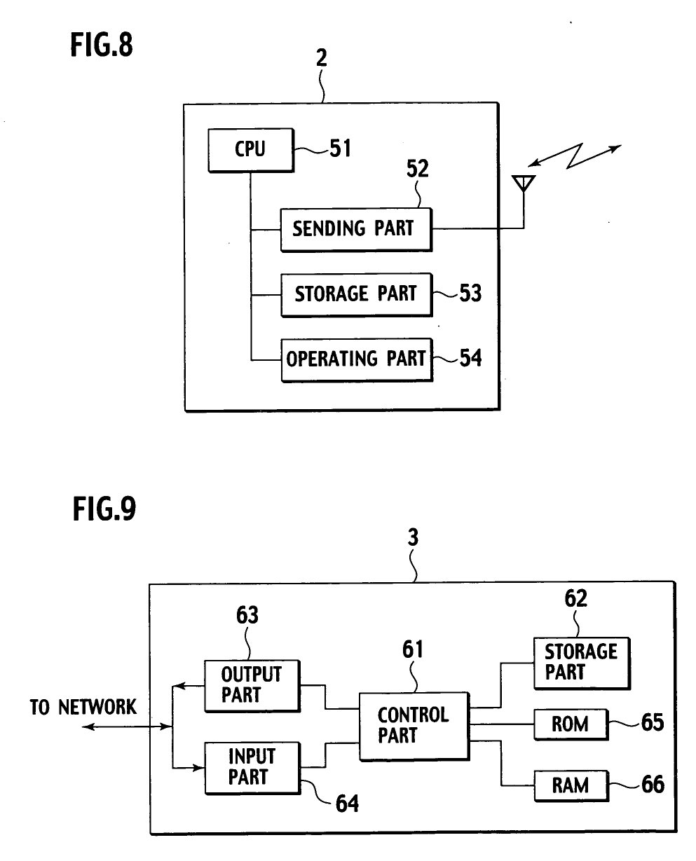

FIG. 8 is a block diagram showing the internal configuration of the remote control unit 2. As shown in FIG. 8 the remote control unit 2 comprises a CPU 51 that performs main control, a sending part 52 that sends wireless instructions signals to the game medium renting units 1, a storage part 53 that stores each kind of data and an operating part 54 by which an operator can perform each kind of operating input.

FIG. 9 is a block diagram showing the internal configuration of the management server 3. As shown in FIG. 9 the management server 3 comprises a storage part 62 for storing each kind of data relating to the game medium renting machines 1, a control part (management server control means) 61 for performing overall control, an output part (sending means) 63 for sending output data to the network line, and an input part (receiving means) 64 for receiving data sent via the network and a ROM 55 and RAM 66.

The RAM 66 stores data defining groupings of a plurality of game medium renting machines 1 grouped into each game island.

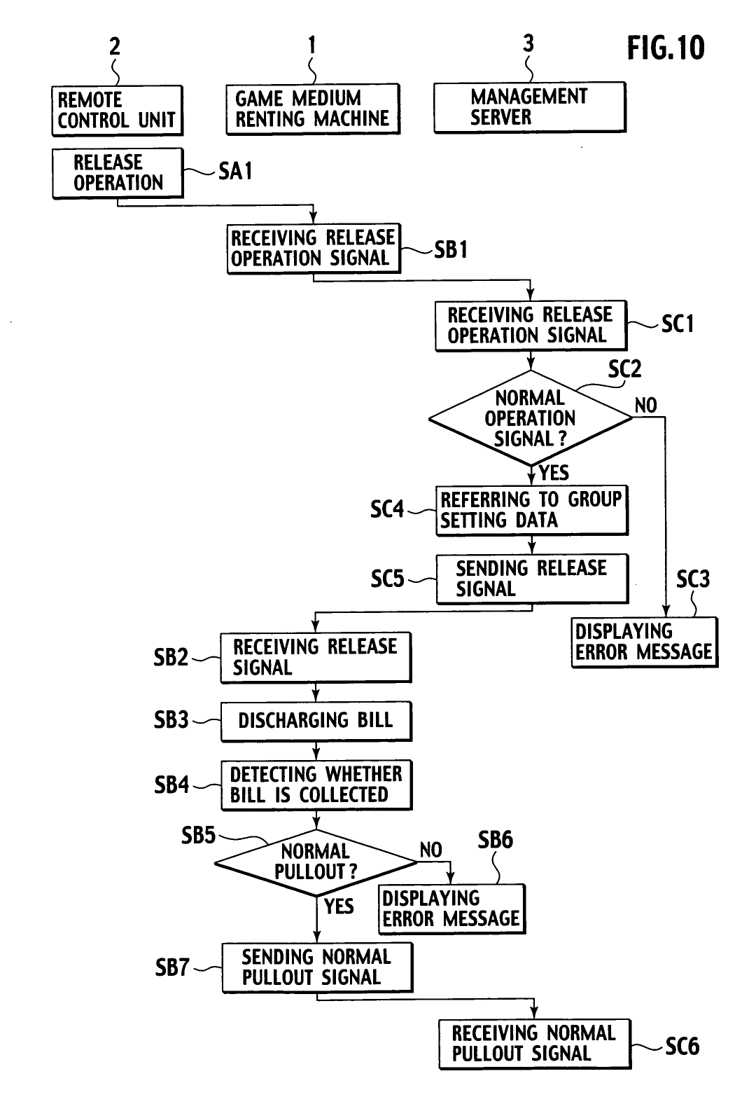

The operations of the management system 100 for game medium renting machines configured as described above occurring when money accommodated inside a game medium renting machine is collected will now be described with reference to the sequences illustrated in FIG. 10.

First, the operator performs a release operation in the vicinity of a game medium renting machine 1 using the operating part 54 of the remote control unit 2, in order to take out the bills (SA1). Accordingly a release operation signal is sent from the sending part 52 of the remote control unit 2 and this signal is received at the receiving part 71 of the game medium renting machine 1 (SB1).

Next, the game medium renting machine 1 sends the release operation signal to the management server 3 via the network 4 and the release operation signal thus sent is received at the management server 3 (SC1). At the control part 61 of the management server 3 a determination is made as to whether or not the release operation signal thus received is normal (SC2) and if it is not an error message is displayed (SC3).

If a normal release operation signal is received a reference is made to group setting data stored inside the RAM 66 and the game medium renting machines 1 subject to the release instruction are specified (SC4). Group setting data specifies for example a game island in a game hall, a game island representing a single block of gaming machines. The release signal is then sent to the game medium renting machines 1 for the release (SC5).

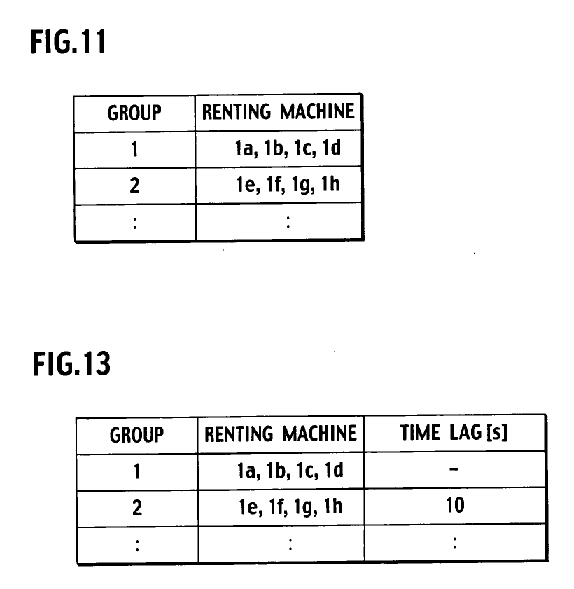

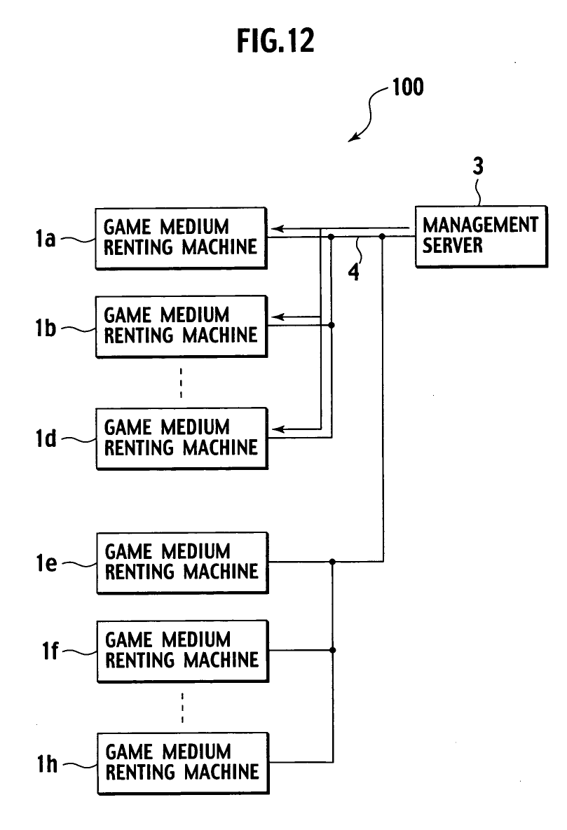

As shown in FIG. 11 for example, renting machines 1a-1d correspond to group 1, renting machines 1e-1h correspond to group 2 and this arrangement is stored as group setting data. As shown in FIG. 1 renting machine 1a receives the release operation signal and thereafter, this release operation signal is forwarded to the management server, and as shown in FIG. 12, the management server sends a release signal to all of the renting machines 1a-1d belonging to group 1.

If a release operation signal is received by any of the renting machines 1b-1d, in the same manner, a release signal is sent to all of the renting machines 1a-1d belonging to group 1 by the management server.

If any of the renting machines 1e-1h receives a release operation signal, the signal is forwarded to the management server and the management server sends a release signal to all of the renting machines 1e-1h belonging to group 2.

Note that the release operation signal corresponds to a discharge request signal and a release signal to a discharge instruction signal.

Once a release signal sent from the management server 3 is received at the game medium renting machines 1 (SB2), bills housed inside the holding case 21 are discharged (SB3). That is to say, once a release signal is sent from the management server 3 via the communication part 50 shown in FIG. 7 the shutter motor 33 is made to operate opening the shutter of the bills insertion opening 11, moreover, by the operation of the pushing out motor 23 bills inside the holding case 21 are discharged from the bills insertion opening 11.

In other words, the pushing out motor 23 shown in FIG. 5 is made to rotate and as shown in FIG. 6, the end part 27a of the bracket 27 is made to move in the notch part 22a formed in the metal sideboard 22 and the bills P held inside the holding case 21 are delivered out. Thus, the condition is one in which a wad of bills are projecting out from the bills insertion opening 11, as shown in FIG. 4.

In this condition a staff member collecting money can collect the bills consecutively from each game medium renting machine. Accordingly, that staff member does not need to complete the laborious task of opening the lock of each individual game medium renting machine, further, as the bills accommodated inside the game medium renting machine are protruding from the bills insertion opening 11 they can be easily picked up, thereby improving the efficiency of the money collection operation.

Further, by operating the remote control unit 2 bills housed inside each game medium renting machine 1 can be discharged, thereby obviating the need for the staff member concerned to perform the troublesome task of going to the location at which the management server 3 is located and performing the discharge operation.

Additionally, the staff member responsible for collecting money can discharge bills from each game medium renting machine 1 from a position at which they can be visually verified and as the collection operation can be performed promptly there is a reduced risk of money being stolen.

### Second Embodiment

The second embodiment of the present invention will now be described with reference to the drawings. As shown in FIG. 1 with respect to the second embodiment also, the management system 100 comprises a plurality of game medium renting machines 1 installed inside a game hall, a remote control unit (portable unit) 2 capable of communicating with each of the game medium renting machines 1 and a management server 3 connected via a network 4 to each of the game medium renting machines.

The configuration of the game medium renting machines 1, the remote control unit 2 and the management server 3 is the same as the respective configurations of those parts according to the first embodiment and thus a description of those parts is omitted here. On the other hand, group setting data stored in the RAM 66 of the management server 3 and the operations occurring when bills, are collected, differ to the data and operations of the first embodiment and are thus described hereinafter.

Group setting data stored in the RAM 66 of the management server 3 will now be described with reference to FIG. 13. In the case of this second embodiment the group setting data comprises information defining renting machines belonging to each group and timing differences between groups. For example, as shown in FIG. 13, renting machines 1a-1d belong to group 1, renting machines 1e-1h belong to group 2 and the time lag from the sending of a signal to group 1 to the sending of a signal to group 2 is 10 seconds.

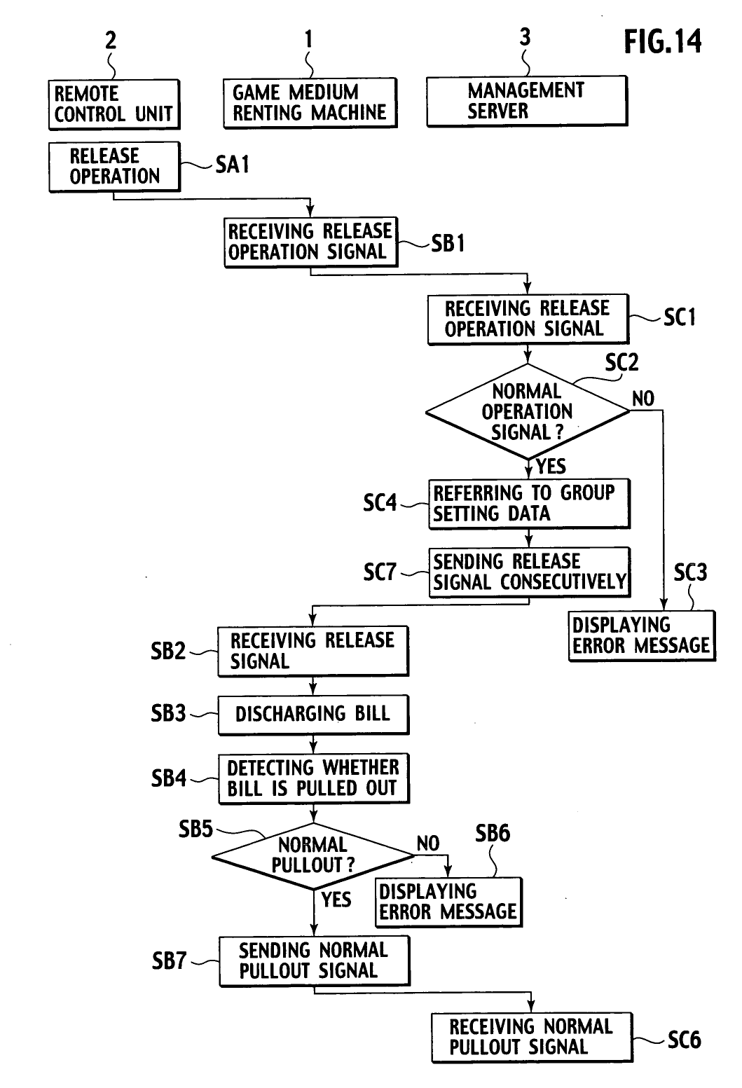

Next, the money collection operations performed in the case of the second embodiment will be described with reference to FIG. 14, however the operations from the release operation using the remote control unit 2 (SA1) to the referencing of group setting data by the management server 3 (SC4) are the same as in the case of the first embodiment and a description of these is thus omitted here.

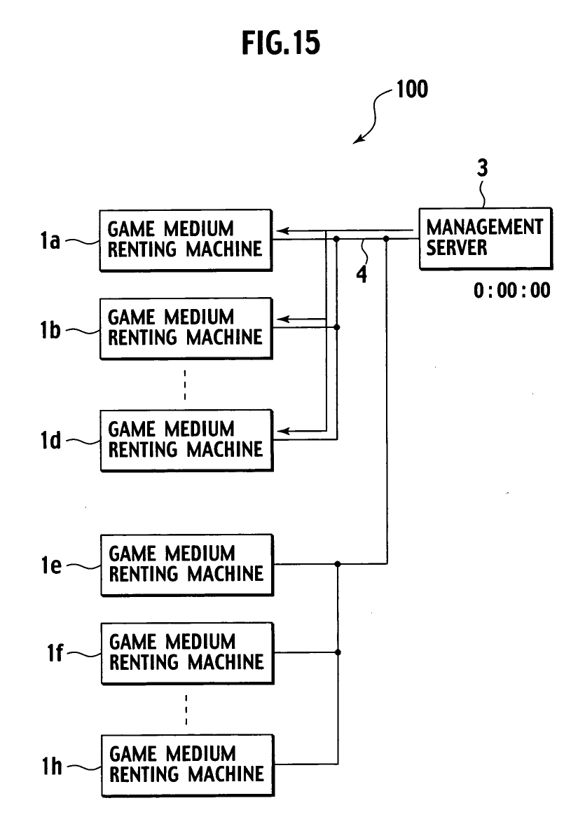

The management server 3 references the group setting data shown in FIG. 13 and then sends a release signal to renting machines 1a-1d of group 1 (SC7) as shown in FIG. 15. The operations of the renting machines 1a-1d receiving the release signal (SB2 onward) are omitted from this explanation as they are the same as those in the case of the first embodiment.

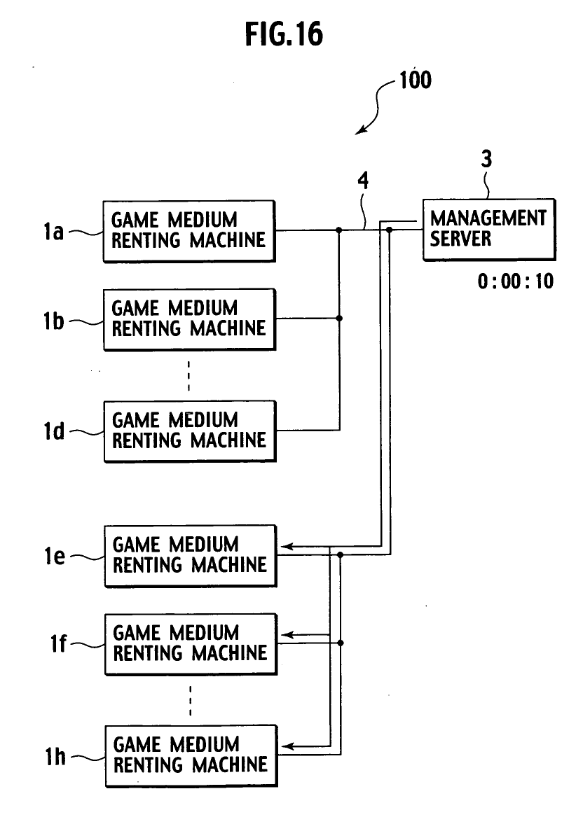

10 seconds after the management server 3 sends the release signal to the renting machines 1a-1d the management server 3 sends a release signal to the renting machines 1e-1h of the second group (SC7), as shown in FIG. 16. The operations of the renting machines 1e-1h receiving the release signal (SB2 onwards) also are not described here as they are the same as those in the case of the first embodiment.

As described above, 10 seconds after the sending of the release signal to group 1 a release signal is sent to group 2, thus in the case of the second embodiment, bills are discharged from the renting machines 1e-1h of group 2 10 seconds after bills are discharged from the renting machines 1a-1d of group 1.

This explanation has proceeded in describing only a group 1 and a group 2, however it goes without saying that the number of groups can be three or more as required. Further, there is no need for the difference in the timing of the sending of the signal to the groups to be fixed. For example, it is acceptable for the time lag of the sending of the signal to group 1 and group 2 to be 10 seconds and for this time lag between group 2 and a group 3 to be 20 seconds.

It is preferable for the time required for a staff member responsible for collecting money to collect all of the bills from the plurality of renting machines 1 belonging to a group (e.g. group 1) to be the time that is the time lag between that group 1 and the next group (e.g. group 2). By setting this time lag in this way, the bills can be made to be discharged from the renting machines 1 of the second group immediately after the money collecting staff member has completed collecting all of the bills from the plurality of renting machines 1 comprising group 1. Thus, the collecting staff member can start the money collection operation from the renting machines 1 of the second group soon after the bills are discharged from those renting machines.

The invention according to this second embodiment obtains the same effects as that according to the first embodiment. Further, as the bills are discharged consecutively from the game medium renting machines 1 belonging to each group at a prescribed lag (e.g. 10 seconds), the bills can be made to be discharged from the game medium renting machines 1 of a group late in the order for money collection at a time delay differential matched to the position of that group in the order. Accordingly, it is possible to adjust the timing of bills discharge in coordination with the time required for the performance of the money collection operation by a collecting staff member, thereby avoiding a situation in which bills are projecting from renting machines 1 for a long time.

Although the present invention has been fully described in connection with the preferred embodiments thereof, this explanation is illustrative and not restrictive and it is apparent to those skilled in the art that changes and modifications to elements described herein that nonetheless furnish the same functionality are to be understood as included within the scope of the present invention.

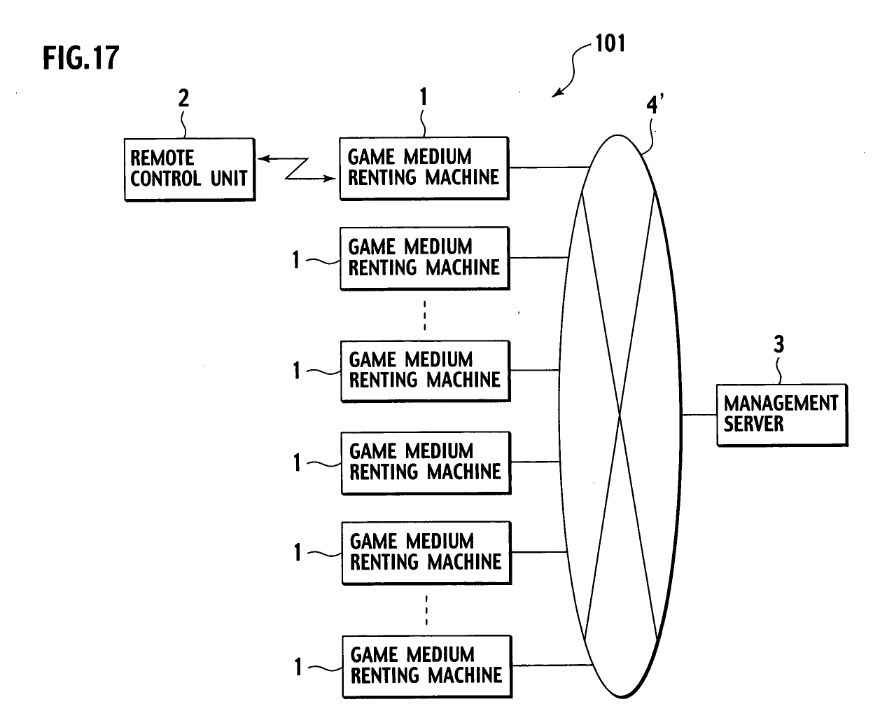

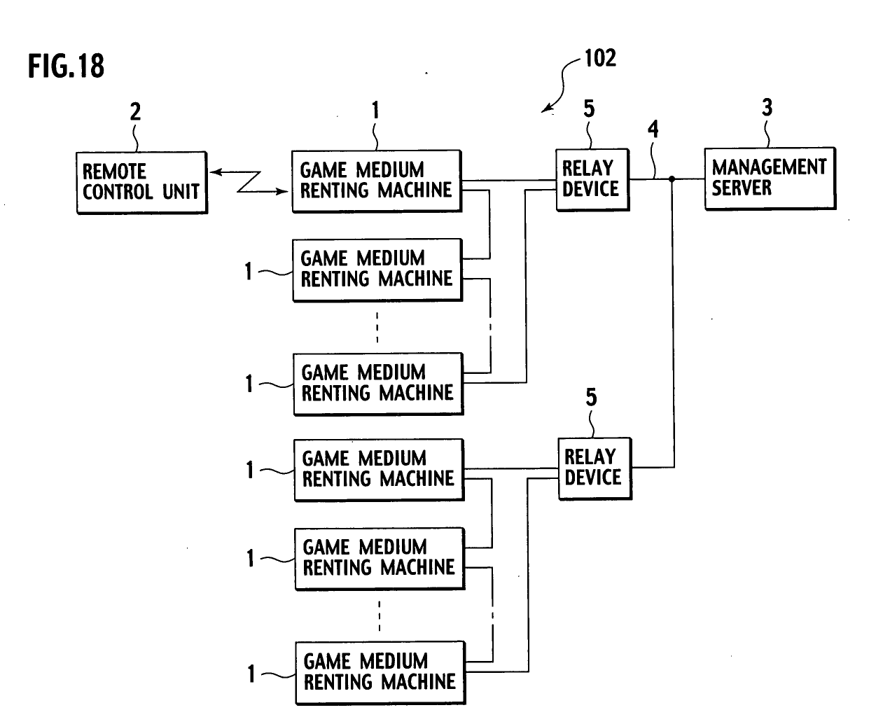

For example, the above described game medium renting machine management system may furnish a configuration as that shown in FIG. 17 or FIG. 18 that differs to that shown in FIG. 1. In the case of the management system 101 shown in FIG. 17 each of the game mediums renting machines 1 are connected so as to enable communication with the management server 3 via the Internet. Or, in the case of the management system 102 shown in FIG. 18 a relay device 5 is provided that facilitates communication between each of the plurality of game medium renting machines 1 and the management server 3.

Moreover, the above described embodiments provide examples in which bills held in a machine are discharged in response to a release signal issued from the remote control unit 2, however a configuration is suitable in which a verification card such as an IC card or the like can be used instead of the remote control unit 2 and the pushing out motor 23 is made to operate to discharge the bills being held, after verification with the game medium renting machines 1 is confirmed.

Further, in the case of the above described embodiments the renting machines are set in groups for each “game island,” however this description is illustrative and not restrictive and these different groups can be set in a manner that makes it easy for bills to be collected by a staff member.

Moreover, in the above described embodiments the cash money held inside a game medium renting machine 1 is discharged, however by discharging cash value cards such as a prepaid card or the like it is also possible to make the card collection operation easy.

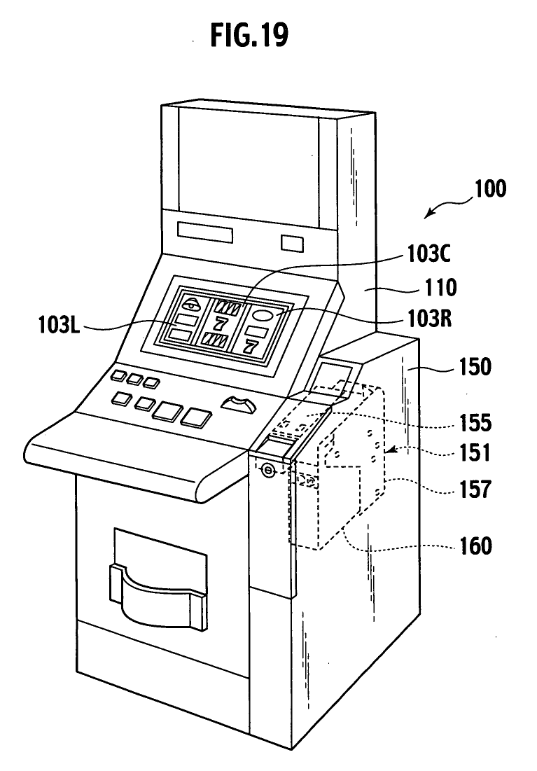

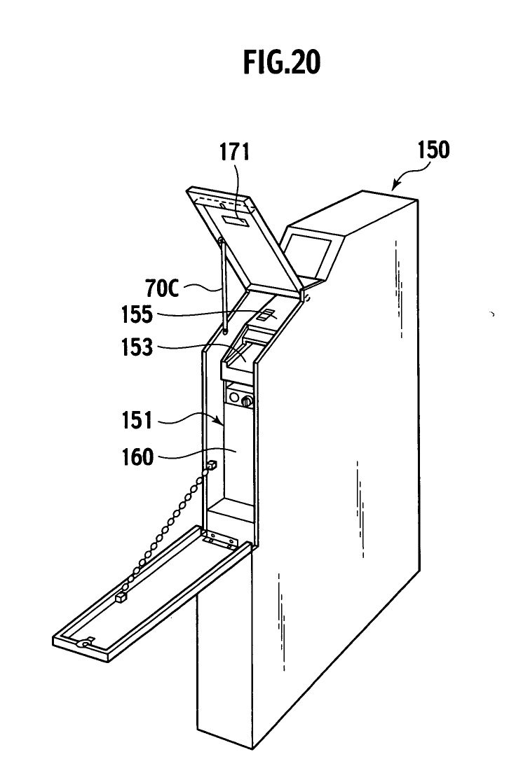

Further, the description of the above in documents provided examples in which the plurality of game medium renting machines 1 are arranged between pachinko gaming machines, however as shown in FIG. 19 and FIG. 20 the present invention is also suitable when a game medium renting machine is arranged beside a slot machine.

The slot machine 100 shown in FIG. 19 provides a first cabinet 110 in which is incorporated a reel unit (a unit for playing the game that can be referred to as a gaming unit) in which three rotating reels 103L, 103C and 103R each drawn with symbols can rotate on a single horizontal axis and a second cabinet 150 disposed inside this first cabinet 110, in which a bill receiving device 151 for receiving bill is arranged.

FIG. 20 is an enlarged perspective view of the second cabinet 150 shown in FIG. 19. The receiving device 151 further provides a bill receiving opening 153 for actually receiving bills, a main body 157 equipped with a bill distinguishing part 155 for distinguishing the validity of bills inserted from the bill receiving opening 153, and a holding part (safe) 164 for stocking bill the validity of which has been confirmed by the bill distinguishing part 155, and that can be pulled out in the front wise direction in relation to the main body 157. The receiving device 151 further provides a receiving part for receiving discharge instruction signals and a discharge mechanism the same as that provided in the first embodiment. When a discharge instruction signal is received from the management server 3, bills are discharged from a bill insertion opening 171.

What is claimed is:

1. A game medium renting machine management server connected via a network to a plurality of game medium renting machines capable of communicating with a portable device which can be carried by an operator, that manages each of the game medium renting machines, comprising:
a signal receiver configured to receive a signal sent from any of the game medium renting machines;
a signal sender configured to send a signal to any of the game medium renting machines; and
a control part configured to control sending of a discharge instruction signal for discharging a bill or a cash value card from the signal sender to a first game medium renting machine of the game medium renting machines if a discharge request signal for discharging a bill or a cash value card is sent from the portable device and is received by the signal receiver via any of the game medium renting machines and the network.

2. The management server according to claim 1 wherein the control part controls sending of a second discharge instruction signal from the signal sender to a second game medium renting machine after a predetermined time has elapsed from the sending of a first discharge instruction signal from the signal sender to the first game medium renting machine.

3. A game medium renting machine management system comprising a plurality of game medium renting machines that rent a game medium when a bill or a cash value card is inserted, a portable device capable of communication between itself and each of the game medium renting machines and a management server connected via a network to the plurality of game medium renting machines, that manages each of the game medium renting machines wherein:
each game medium renting machine comprises a communicating means capable of performing communication between itself and the portable device; a holder configured to accommodate inserted bills or cash value cards; and a money discharger configured to discharge bills or cash value cards accommodated inside the holder; and
the management server comprises a signal receiving means for receiving a signal sent from any of the game medium renting machines; a signal sender configured to send a signal to any of the game medium renting machines; and a control part configured to control the sending of a discharge instruction signal from the signal sender to at least one of the game medium renting machines when a discharge request signal is sent from the portable device and received at the signal receiver via the game medium renting machine and the network.

4. The management system according to claim 3 wherein
the management server further comprises a storage configured to store a time lag and
the control part controls the sending of a second discharge instruction signal from the signal sender to a second game medium renting machine after the time lag has elapsed from the sending of a first discharge instruction signal from the signal sender to a first game medium renting machine.

5. The game medium renting machine management system according to claim 3 wherein
the management server further comprises a storage configured to store information defining game medium renting machines belonging to a first group and game medium renting machines belonging to a second group and
the control part performs control of sending of the discharge instruction signal from the signal sender to all of the game medium renting machines belonging to the first group if the signal receiver receives a discharge request signal from any of the game medium renting machines belonging to the first group and performs control of sending of the discharge instruction signal from the signal sender to all of the game medium renting machines belonging to the second group if the signal receiver receives a discharge request signal from any of the game medium renting machines belonging to the second group.

6. The game medium renting machine management system according to claim 3 wherein
the management server further comprises a storage configured to store information defining the game medium renting machines belonging to the first group, the game medium renting machines belonging to the second group and a time lag between the first group and the second group, and
the control part controls the sending of the discharge instruction signal to all of the game medium renting machines belonging to the second group after the time lag has elapsed from the sending of the discharge instruction signal from the sender to all of the game medium renting machines belonging to the first group, once the receiver receives a discharge request signal sent from a game medium renting machine belonging to the first group.

7. The game medium renting machine management system according to claim 3 wherein the portable device has either a remote control mechanism for sending a discharge request signal to the game medium renting machines for discharge of bills or cash value cards, or a verification card for sending a discharge request signal to each game medium renting machine to discharge bills or cash value cards after being verified by the game medium renting machines.
